(19) United States
(12) Patent Application Publication
(10) Pub. No.: US 2016/0295596 A1
(43) Pub. Date: Oct. 6, 2016

(54) Joint Radio-Frequency/Baseband Self-Interference Cancellation Methods and Systems

(71) Applicant: Huawei Technologies Canada Co., Ltd., Kanata (CA)

(72) Inventors: Ahmed Masmoudi, Montreal (CA); Tho Le-Ngoc, Montreal (CA)

(21) Appl. No.: 14/675,278

(22) Filed: Mar. 31, 2015

(51) Int. Cl. H04W 72/08; H04B 1/40; H04L 5/16

(52) U.S. Cl. CPC H04W 72/082; H04L 5/16; H04B 1/40

(57) ABSTRACT

System, method, and apparatus embodiments are provided for a joint radio-frequency/baseband self-interference reduction system to obtain an intended signal in a full-duplex capable transceiver. In an embodiment, a method for reducing self-interference (SI) in a full-duplex capable transceiver includes obtaining an adjusted signal, wherein the adjusted signal is a difference signal between a received signal in an analog domain and an estimated SI, wherein the estimated SI is estimated according to an SI received at a receiver during a half-duplex operation; and obtaining an intended signal, wherein the intended signal is a difference signal between the adjusted signal in a digital domain and an estimated residual SI, and wherein the estimated residual SI is an amount of SI remaining in the adjusted signal after removal of the estimated SI from the received signal.

### TECHNICAL FIELD

The present invention relates to an apparatus, system, and method for wireless communications, and, in particular embodiments, to an apparatus, system, and method for self-interference cancellation in wireless communication systems.

### BACKGROUND

Current half-duplex wireless communication systems employ two orthogonal channels to transmit and receive. Full-duplex (FD) systems allow better exploitation of these resources by transmitting and receiving on the same channel. The main deterrent in employing FD systems is the large self-interference (SI) as compared to the intended signal. It is, therefore, desirable to have apparatuses, systems, and methods to reduce the SI in order to allow the intended signal to be detected.

### SUMMARY OF THE INVENTION

In accordance with an embodiment, a method for reducing self-interference (SI) in a full-duplex capable transceiver includes obtaining an adjusted signal, wherein the adjusted signal is a difference signal between a received signal in an analog domain and an estimated SI, wherein the estimated SI is estimated according to an SI received at a receiver during a half-duplex operation; and obtaining an intended signal, wherein the intended signal is a difference signal between the adjusted signal in a digital domain and an estimated residual SI, and wherein the estimated residual SI is an amount of SI remaining in the adjusted signal after removal of the estimated SI from the received signal.

In accordance with another embodiment, a method for reducing self-interference (SI) in a full-duplex capable transceiver includes obtaining, by the transceiver, an adjusted signal, wherein the adjusted signal is a difference signal between a received signal in an analog domain and an estimated SI signal, wherein the estimated SI signal is estimated according to an SI signal received at a receiver during a training period during a half-duplex operation; and obtaining, by the transceiver, an intended signal according to an estimated residual SI signal and the adjusted signal.

In accordance with another embodiment, a full-duplex capable wireless network component includes an antenna sub-system configured for full-duplex operation; a self-interference (SI) channel estimation component configured to estimate an SI signal during a training phase mode; an radio-frequency (RF) self-interference cancellation stage component configured to obtain an adjusted RF signal according to a difference signal between a received RF signal and the estimated SI signal in a RF domain during a full-duplex operation mode; an analog-to-digital converter (ADC) configured to convert the adjusted RF signal to a digital adjusted signal; and a baseband SI cancellation stage configured to obtain the digital intended signal in a digital domain according to a difference signal between the digital adjusted signal and a residual SI signal.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a network for communications;

FIG. 2 is a block diagram of an embodiment of a system for SI channel estimation during the HD-initialization phase;

FIG. 3 is a block diagram of an embodiment of a system for SI channel reduction during the FD operational phase;

FIG. 4 is a flowchart illustrating an embodiment of a method for SI reduction in a FD transceiver system;

FIG. 5 is a flowchart illustrating an embodiment of a method for SI estimation in a FD transceiver system and

FIG. 6 is a processing system that can be used to implement various embodiments.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Full-duplex operation by allowing simultaneous transmission/reception over the same channel has the potential to double the transmission rate of half-duplex if the self-interference signal can be perfectly suppressed (or reasonably suppressed) from the received signal. However, as mentioned above, one of the key deterrents in implementing a full-duplex transceiver is the large SI from the wireless device's own transmission. The SI is usually several orders of magnitude higher than the signal of interest because the later signal crosses longer distance than does that of the SI signal. Recent research results showed that, using different cancellation stages, it is possible to sufficiently attenuate the SI such that the signal of interest is properly detected.

In a practical environment, it is difficult, if not impossible, to completely cancel the self-interference due to imperfect channel estimation. Therefore, channel estimation is a critical issue in full-duplex systems. In one system, the coefficients of the self-interference channel are obtained in the frequency domain by dividing the received signal by the known transmit symbol over each subcarrier. However, this approach ignores the sparsity of the channel. In another system, a two-step Least Square (LS)-based estimator is used where a first estimate of the self-interference channel is obtained by considering the actual signal as additive noise. After that, the interference is suppressed and the resulting signal is used to detect the intended data. A more precise estimate of the channel is then obtained by jointly estimating the self-interference and intended signal channels using the known transmitted data and detected data. However, an initial estimate of the intended signal channel is important in the detection of the intended data.

Disclosed herein are apparatuses, systems, and methods for SI reduction in a FD system. In an embodiment, the SI cancellation or reduction is performed in the radio-frequency (RF) level to avoid saturation/overloading of the low noise amplifier (LNA) and analog-to-digital converter (ADC). The residual SI that remains after the RF SI cancellation is reduced in the baseband. An estimate of the SI signal is determined in order to subtract it from the received signal. To obtain this estimate, the transmit SI data is known, but the SI propagation channel may be unknown. Disclosed herein is a transmission protocol for switching from HD to FD in order to estimate the SI channel. In an embodiment, a half-duplex transmission period is used at the beginning of a transmission to estimate the self-interference channel and then used reduce the self-interference without affecting the intended signal when switching to full-duplex transmission at the completion of the estimation period. The mode is switched from HD to FD once the training period is over. This protocol allows for good channel estimation and SI cancellation or reduction performance.

In an embodiment, during a short HD-initialization phase, the wireless node receives only the self-interference from a transmit data and estimates the SI channel that can be used to reduce the SI during the FD period. This HD-initialization period allows accurate estimates of the SI channel to establish SI-cancellation (or reduction) at the RF. The transmitter (Tx) adjusts its Tx power to allow more accurate SI channel estimation using its existing receiver (Rx) ADC.

In an embodiment, in FD operation, the SI is cancelled before the LNA/ADC to avoid LNA/ADC overloading/saturation and further self-interference suppression can be done after ADC at the baseband. Usually, no additional processing can be done before at least some of the SI is cancelled or reduced. A replica of the self-interference for cancellation can be created from the known transmit signal and the estimate of the self-interference channel. The SI-channel estimate obtained in the initial HD period is fed back to the RF cancellation stage to create a cancellation signal and subtract it from the received signal. In an embodiment, residual SI exists due to estimation error. Additional processing is performed in the digital domain to further reduce the SI.

Embodiments of the disclosure can be combined with existing passive cancellation by using passive circuit and antenna combinations.

In an embodiment, disclosed, is a self-interference channel estimation and cancellation system and method in a full-duplex transceiver in two steps. In an embodiment, the first accurate self-interference channel estimate is obtained in a short initial half-duplex period for the radio-frequency (RF) self-interference-cancellation stage prior to the LNA/ADC. Noting the self-interference channel sparse structure dominated by a relatively small number of clusters of significant paths, in an embodiment, its sensing matrix satisfies the restricted isometry property (RIP). Hence, compressed-sensing (CS) theory can be applied to exploit its sparsity by using a mixed-norm optimization criteria to return the non-zero coefficients and to develop an accurate CS-based self-interference channel estimate with much fewer samples than the linear reconstruction method. In an embodiment, the regularization parameter is derived. The regularization parameter can be selected to keep the residual self-interference not exceeding the intended signal level.

In the second step during the full-duplex operation, a subspace-based process is disclosed to jointly estimate the residual self-interference and intended signal channels for the baseband self-interference cancellation stage. Since the channels are obtained up to a matrix ambiguity, disclosed is a method to find the expression of the self-interference channel ambiguity and a phase ambiguity resolution scheme for the intended signal channel estimation with much smaller number of training samples than traditional data-aided estimator. In an embodiment, a substantially minimal amount of training data is used. The small amount of training data used in the disclosed channel estimator can be explained by the fact that the estimator exploits the information bearing in the unknown data to find the subspace of the transmit signal. The knowledge of the signal subspace reduces the number of the remaining parameters to estimate compared to the LS estimator.

In an embodiment, two channel estimation techniques for the RF and baseband self-interference cancellation stages in full-duplex MIMO transceivers are disclosed. The first process for the RF self-interference cancellation stage is based on the concept of compressed sensing to reduce the self-interference power to at least the same level of the intended signal. Then, in the baseband cancellation stage, a subspace-based channel estimator is applied to find the residual self-interference channel and cancel the residual self-interference. This disclosed process performs a joint estimation of the residual self-interference and intended signal channels by exploiting the available knowledge of the self-signal while the intended signal is unknown. Compared to the standard non-blind LS estimator, the disclosed scheme does not require training blocks to find the residual self-interference channel and needs fewer training data to solve the intended signal channel ambiguity and, therefore, offers better bandwidth efficiency. Simulation results have shown that the disclosed process improves the channel estimation accuracy and the cancellation performance.

In an embodiment, a method for reducing self-interference (SI) in a full-duplex capable transceiver is disclosed. The method includes subtracting, with the transceiver, an estimated SI signal from a received signal in an analog domain to produce an adjusted signal, wherein the estimated SI signal is estimated according to a transmitted signal received at the transceiver during a half-duplex operation. The method also further includes subtracting, with the transceiver, an estimated residual SI signal from the adjusted signal in a digital domain to obtain an intended signal, wherein the residual SI is an amount of SI signal remaining in the adjusted signal after removal of the estimated SI from the received signal. In an embodiment, subtracting the estimated SI signal is performed before the adjusted signal arrives to a low noise amplifier and before the adjusted signal arrives to an analog-to-digital convertor. In an embodiment, the transmit power of the transceiver is adjusted according to the transmitted signal received at its own receiver during the half-duplex operation to improve an accuracy of the SI channel estimation.

In another embodiment, a method for reducing self-interference (SI) in a full-duplex capable transceiver is disclosed. The method includes determining, by the transceiver, an estimated SI signal during a training period; subtracting, by the transceiver, the estimated SI signal from a received signal during full-duplex operation to produce an adjusted signal; estimating, by the transceiver, a residual SI signal according to the estimated SI signal, wherein the residual SI signal comprises an error in the estimated SI signal; and subtracting the residual SI signal from the adjusted signal to produce an intended signal. The estimated SI signal is subtracted from the received signal in a radio-frequency (RF) domain before the received signal is amplified and converted into a digital signal. The residual SI signal is subtracted from the adjusted signal in a baseband. In an embodiment, the power of the SI signal is reduced according to the estimated SI signal obtained in the training period.

In another embodiment, a full-duplex capable wireless network component is disclosed. The wireless network component includes an antenna sub-system configured for full-duplex operation; a self-interference (SI) channel estimation component configured to estimate a SI signal during a training phase mode; an radio-frequency (RF) self-interference cancellation stage component configured to subtract the estimated SI signal from a received RF signal in a RF domain to produce an adjusted RF signal during a full-duplex operation mode; an analog-to-digital convertor (ADC) configured to convert the adjusted RF signal to a digital adjusted signal; and a baseband SI cancellation stage configured to subtract a residual SI from the digital adjusted signal in a digital domain. In an embodiment, the estimated SI signal is subtracted from the received signal in software. In an embodiment, the digital intended signal is obtained by subtracting the residual SI signal from the digital adjusted signal in software. The SI channel estimation component is configured to determine the estimated SI according to a compressed-sensing-based procedure and/or according to a mixed-norm optimization criteria that returns non-zero coefficients for a compressed-sensing based self-interference channel estimate. The baseband SI cancellation stage is configured to determine the residual SI according to a maximum likelihood function. The antenna sub-system comprises a multi-antenna sub-system and the training phase mode is a half-duplex mode.

There are many reasons that render it beneficial to develop another process in the second cancellation stage different from the process in the first stage. First, the residual self-interference channel after the first cancellation stage is completely random without any specific sparse structure. Moreover, in an embodiment, it may be desirable to jointly estimate the residual self-interference and the intended signal channels without knowing the data. In this situation, the compressed sensing estimator cannot recover the channel coefficients without a perfect knowledge of the data.

Simulation results show that the disclosed processes outperform the LS processes with better bandwidth efficiency since they do not require any training data to estimate the self-interference channel. The disclosed processes offer the remarkable signal-to-residual-self-interference-and-noise ratio (SINR) after the RF and baseband self-interference-cancellation stages approaching the signal-to-noise ratio (SNR).

In this disclosure, we adopt the following notations. (.)^{T}, (.)^{H} and (.)^{#} refer to matrix transpose, conjugate transpose, and pseudo-inverse, respectively. For a matrix M, we use det(M) and trace(M) to denote the determinant and the trace, respectively. The operator ⊕ refers to the Kronecker product of two matrices. Ip refers to the p×p identity matrix. └x┘ rounds the real x to the largest integer smaller or equal to x. Finally, let ∥.∥₁ and ∥.∥₂ denote the l1- and the l2-norms, respectively and ∥.∥₀ counts the number of nonzero entries of its argument.

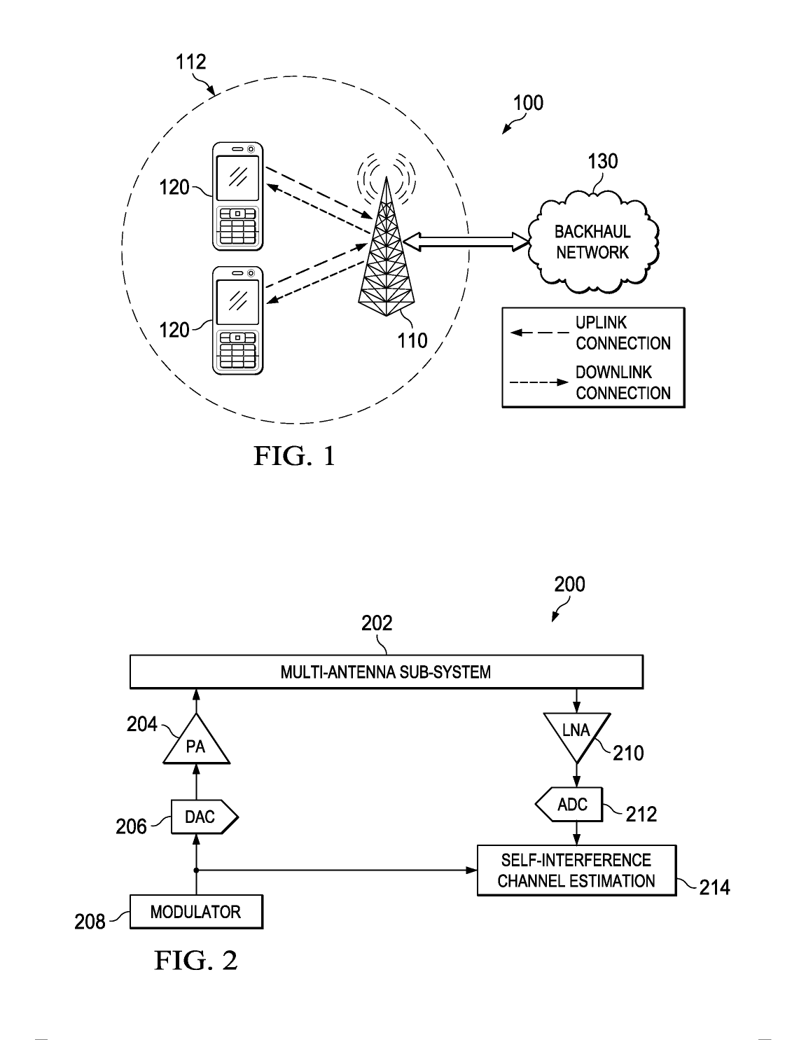

FIG. 1 illustrates a network 100 for communicating data. The network 100 comprises an access point (AP) 110 having a coverage area 112, a plurality of user equipment (UEs) 120, and a backhaul network 130. As used herein, the term AP may also be referred to as a TP and the two terms may be used interchangeably throughout this disclosure. The AP 110 may comprise any component capable of providing wireless access by, inter alia, establishing uplink (dashed line) and/or downlink (dotted line) connections with the UEs 120, such as a base transceiver station (BTS), an enhanced base station (eNB), a femtocell, and other wirelessly enabled devices. The UEs 120 may comprise any component capable of establishing a wireless connection with the AP 110. The backhaul network 130 may be any component or collection of components that allow data to be exchanged between the AP 110 and a remote end (not shown). In some embodiments, the network 100 may comprise various other wireless devices, such as relays, femtocells, etc.

In an embodiment, the AP 110 and UEs 120 are configured to operate in FD mode. In order to provide high isolation of transmitter power from on frequency co-located receivers in the AP 110, the AP 110 includes a self-interference cancellation apparatus and system described in more detail below. In an embodiment, the AP 110 is a cellular AP. In another embodiment, the AP 110 is a WiFi AP.

FIG. 2 is a block diagram of an embodiment of a system 200 for SI channel estimation during the HD-initialization phase. System 200 includes a modulator 208, a plurality of digital-to-analog converters (DACs) 206, a plurality of power amplifiers (PAs) 204, a multi-antenna sub-system 202, a plurality of low noise amplifiers (LNAs) 210, a plurality of analog-to-digital converters (ADCs) 212, and a SI channel estimation component 214. The modulator 208 is configured to modulate transmit data onto a signal(s) that is converted to analog by one of the DACs 206. The analog transmit signal is amplified by one of the PAs 204 and transmitted to the multi-antenna sub-system 202 to be broadcast. The multi-antenna sub-system 202 is further configured to receive the transmitted signals from the system 200 and transmits the received signal to the LNAs 210 for amplification and then to the ADCs 212 for conversion into a digital signal. The self-interference channel estimation component 214 samples the received signal from the ADCs 212 and determines a method for estimating the SI signal according to the received signal and the known transmit signal. The self-interference channel estimation component 214 may include a processor and memory.

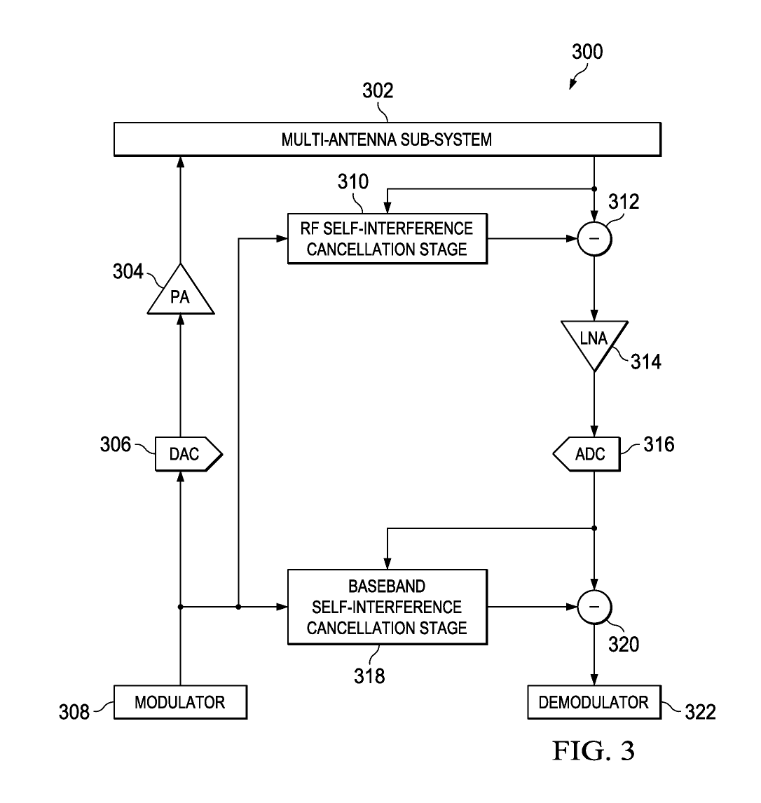

FIG. 3 is a block diagram of an embodiment of a system 300 for SI channel reduction during the FD operational phase. System 300 includes a modulator 308, a plurality of DACs 306, a plurality of PAs 304, a multi-antenna sub-system 302, an RF self-interference cancellation stage 310, a subtractor 312, a plurality of LNAs 314, a plurality of ADCs 316, a baseband self-interference cancellation stage 318, subtractor 320, and a demodulator 322. The modulator 308, the DACs 306, the PAs 304, the multi-antenna sub-system 302, the LNAs 314, and the ADCs 316 operate similarly to corresponding structures in FIG. 2. The RF self-interference cancellation stage component 310 is configured to use the method determined by the self-interference channel estimation component 214 to determine an estimated SI signal according to the current transmit signal received from the modulator 308 and to transmit the estimated SI signal to the subtractor 312 which subtracts the estimated SI signal from the received signal in the RF (i.e., analog) domain to produce an adjusted signal. The adjusted signal is amplified by one of the LNAs 314 and converted to a digital signal by the one of the ADCs 316. The baseband self-interference cancellation stage component 318 uses the estimated SI to determine an estimated residual SI. The residual SI represents the amount of SI that the estimated failed to correct for. The estimated residual SI is provided to the subtractor 320 which subtracts it from the digital adjusted signal to produce the intended signal, which is then provided to the demodulator 322. The RF self-interference cancellation stage component 310 and the baseband self-interference cancellation stage component 318 may include a processor and memory.

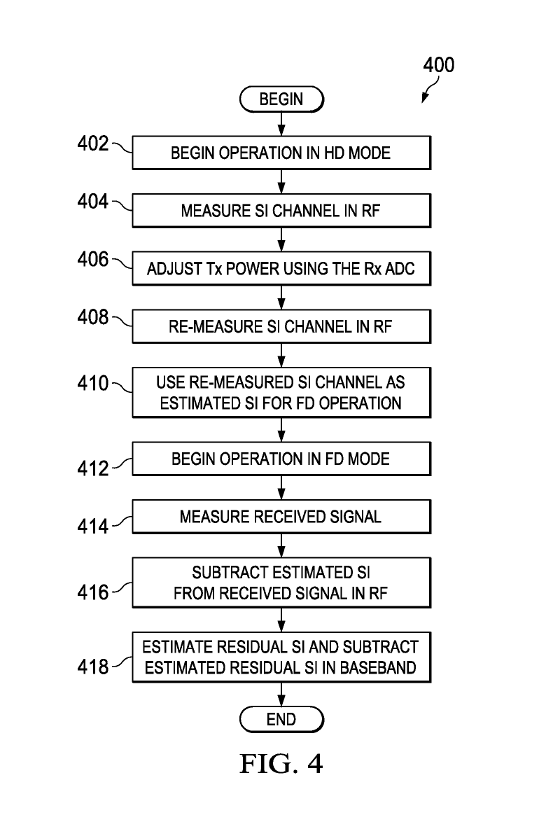

FIG. 4 is a flowchart illustrating an embodiment of a method 400 for SI reduction in a FD transceiver system. The method 400 may be implemented by system 300. The method 400 begins at block 402 where the FD transceiver system begins in HD mode. At block 404, the system measures the SI channel received from transmission by the system. At block 406, the system adjusts the Tx power using the Rx ADC. At block 408, the system re-measures the SI channel. At block 410, the system uses the re-measured SI channel as an estimated SI for FD operation. At block 412, the system begins operation in FD mode. At block 414, the system measures the received signal and, at block 416, the system substracts the estimated SI from the received signal in the analog RF domain before the adjusted signal (received signal minus the estimated SI signal) is amplified by an LNA. At block 418, the system estimates the residual SI and subtracts the estimated residual SI from the adjusted signal in the digital domain in the baseband, after which, the method 400 ends.

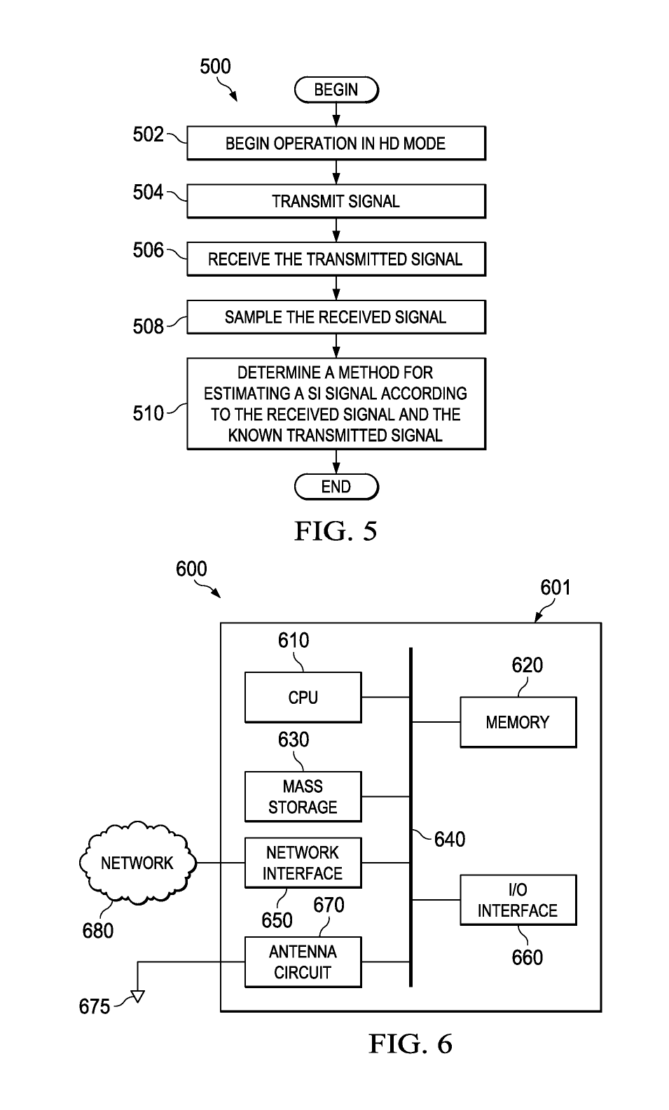

FIG. 5 is a flowchart illustrating an embodiment of a method 500 for SI estimation in a FD transceiver system. The method 500 may be implemented by system 200. The method 500 begins at block 502 where the FD transceiver system begins in HD mode. At block 504, the system transmits a signal and, at block 506, the system receives the transmitted signal. At block 508, a self-interference channel estimation unit samples the received signal and, at block 510, the self-interference channel estimation unit determines a method for estimating a SI signal according the received signal and the known transmitted signal, after which, the method 500 ends.

I. Full-Duplex System Model

Returning to FIG. 3 which shows a simplified block diagram of a multi-input-multi-output (MIMO) transceiver with Nₜ transmit (Tx) streams and Nᵣ receive (Rx) streams operating in a full-duplex fashion, i.e., simultaneously transmit and receive in the same frequency slot. The simultaneous transmission and reception creates self-interference to be cancelled before demodulation. Beside the Tx-Rx isolation provided in the multi-antenna sub-system, we propose two self-interference-cancellation stages on the Rx side. The radio-frequency (RF) self-interference-cancellation stage is done at RF before low-noise amplifier (LNA) and analog-to-digital converter (ADC) in order to avoid overloading/saturation. The baseband self-interference-cancellation stage is performed after the LNA/ADC to cancel the remaining self-interference at the baseband.

Considering multipath channels, the received n^{th} complex-baseband equivalent sample of the Rx stream r can be written as:

$${y}^{r} ( n ) = {\sum }_{q = 1}^{{N}_{t}} {\sum }_{l = 0}^{{L}_{i}} {h}_{r , q}^{( i )} ( l ) {x}_{q} ( n - l ) + {\sum }_{q = 1}^{{N}_{t}} {\sum }_{l = 0}^{{L}_{s}} {h}_{r , q}^{( s )} ( l ) {s}_{q} ( n - l ) + {w}^{r} ( n ) , \qquad ( 1 )$$

where x_{q}(n) and s_{q}(n), for n=0; . . . ; N−1 are the transmitted samples from the Tx stream q of the same transceiver and from the other intended transmitter, respectively. h_{r,q}⁽ⁱ⁾(l); l=0; . . . ; Li is the Li-tap impulse response of the self-interference channel from Tx stream q to Rx stream r of the same transceiver and h_{r,q}^{(s)}(l); l=0; . . . ; Ls is the Ls-tap impulse response of the intended signal channel from Tx stream q of the other intended transmitter to Rx stream r. w^{r}(n) is the additive thermal noise in Rx stream r. The first and second terms in (1) represent the self-interference and intended signal, respectively. For simplicity, we assume Li=Ls=L. From equation (1), it follows that the vector y(n) can be written as:

$$y ( n ) = {\sum }_{l = 0}^{L} X ( n - l ) {h}^{( i )} ( l ) + S ( n - l ) {h}^{( s )} ( l ) + w ( n ) , \qquad ( 2 )$$

where

y(n)=[y¹(n),y²(n), . . . ,y^{Nr}(n)]^{T},

h⁽ⁱ⁾(l)=[h₁⁽ⁱ⁾(l),h_{2,q}⁽ⁱ⁾(l), . . . ,h_{N}_{ᵣ}_{,q}⁽ⁱ⁾(l)]^{T},

h_{q}⁽ⁱ⁾(l)=[h_{1,q}⁽ⁱ⁾(l),h_{2,q}⁽ⁱ⁾(l), . . . ,h_{N}_{ᵣ}_{,q}⁽ⁱ⁾(l)]^{T},

h^{(s)}(l)=[h₁^{(s)T}(l), . . . ,h_{N}_{ₜ}^{(s)T}(l)]^{T},

h_{q}^{(s)}(l)=[h_{1,q}^{(s)}(l),h_{2,q}^{(s)}(l), . . . ,h_{N}_{ᵣ}_{,q}^{(s)}(l)]^{T},

w(n)=[w¹(n);w²(n), . . . ,w^{N}^{ᵣ}(n)]^{T}. (3)

In equation (2), X(n−l) is a Nᵣ×NₜNᵣ Toeplitz matrix with the first column given by the Nᵣ×1 vector [x₁(n−l), 0, . . . , 0] and the first row given by [x₁(n−l), x₂(n−l), . . . , x_{N}_{ₜ}(n−l)] [symbol] e₁ with e₁ being the 1×Nᵣ vector having one in the first element and zeroes elsewhere. The matrix S(n−l) is constructed in the same way as X(n−l) but with transmitted samples sq(n−l) from the other intended transmitter. Now let the two N_t N_r (L+1)×1 vectors h⁽ⁱ⁾ and h^{(s)} gather all the coefficients of the self-interference and intended signal channels, respectively, i.e.,

h⁽ⁱ⁾=[h^{(i)T}(0),h^{(i)T}(1), . . . ,h^{(i)T}(L)]^{T},

h^{(s)}=[h^{(s)T}(0),h^{(s)T}(1), . . . ,h^{(s)T}(L)]^{T}. (4)

And define:

$$X = ( \begin{matrix}X ( 0 ) & X ( N - 1 ) & … & X ( N - L ) \\ X ( 1 ) & X ( 0 ) & ⋱ & ⋮ \\ ⋮ & & ⋱ & X ( N - 1 ) \\ ⋮ & & & X ( 0 ) \\ ⋮ & & & ⋮ \\ X ( N - 1 ) & X ( N - 2 ) & … & X ( N - L - 1 )\end{matrix} ) \\ S = ( \begin{matrix}X ( 0 ) & X ( N - 1 ) & … & X ( N - L ) \\ X ( 1 ) & X ( 0 ) & ⋱ & ⋮ \\ ⋮ & & ⋱ & X ( N - 1 ) \\ ⋮ & & & X ( 0 ) \\ ⋮ & & & ⋮ \\ X ( N - 1 ) & X ( N - 2 ) & … & X ( N - L - 1 )\end{matrix} ) \qquad ( 5 )$$

The NᵣN×NₜNᵣ(L+1) self-signal matrix X includes samples transmitted from the same transceiver and, the NᵣN×NₜNᵣ(L+1) intended signal matrix S contains samples transmitted from the other intended transmitter. Then, the received NᵣN×1 vector y=[y^{T}(0), . . . , y^{T}(N−1)]^{T} is given by:

y=Xh⁽ⁱ⁾+Sh^{(s)}>+w, (6)

where w is the NᵣN×1 thermal noise vector.

In full-duplex systems, the self-interference, shown by the 1st term in equation (6), is many order of magnitude higher than the intended signal from the other intended transmitter, shown by the 2nd term in equation (6). This imposes different cancellation stages to reduce the self-interference to a sufficiently low level for proper signal detection. The RF cancellation stage aims to suppress the self-interference prior to the LNA/ADC. Since the self-signal matrix X is known, we only need to estimate the self-interference channel h⁽ⁱ⁾ to generate the self-interference replica at RF for cancelation. Remaining self-interference after ADC will be further suppressed by the baseband cancellation stage by digital signal processing at baseband as shown in FIG. 3. The disclosed estimation and cancellation processes for the RF and baseband cancellation stages are discussed below.

II. Compressed-Sensing-Based RF Cancellation Stage

As previously discussed, one major task in the RF cancellation stage is to estimate the self-interference channel vector h⁽ⁱ⁾. Since the self-signal matrix X is known, the straightforward approach to find h⁽ⁱ⁾ is to employ a linear estimator. In general, a linear estimate of h⁽ⁱ⁾ is given by:

ĥ⁽ⁱ⁾=My, (7)

where the NᵣNₜ(L+1)×NᵣN matrix M (to be derived) determines the estimate of h⁽ⁱ⁾. There are a large number of different estimates of h⁽ⁱ⁾. For example, using the least square (LS) criterion, M will be given by (X^{H}X)⁻¹X^{H}, while using minimum mean squared error (MMSE) estimator, M=E{h⁽ⁱ⁾h^{(i)H}}X^{H}(XE{h⁽ⁱ⁾h^{(i)H}}X^{H})⁻¹, where E{.} denotes statistical expectation. While the later needs to knowledge of the second order statistic of the channel, it enjoys substantially lower channel estimate error as compared to the LS estimator. Once an estimate of the self-interference channel is available, the self-interference replica is generated and subtracted from the received signal in equation (6) to obtain:

$$\begin{matrix}\tilde{y} = y - X {\hat{h}}^{( i )} \\ = ( {I}_{{N}_{r} N} - XM ) {Xh}^{( i )} + ( {I}_{{N}_{r} N} - XM ) {Sh}^{( s )} + \tilde{w} ,\end{matrix} \qquad ( 8 )$$

where we have substituted the expression of y from equation (6) into ĥ⁽ⁱ⁾ in equation (7). In order to suppress the self-interference, one should design M such that the 1st term in equation (8), i.e., (I_{N}_{ᵣ}_{N}−XM)Xh⁽ⁱ⁾, approaches zero. For the LS estimator, the matrix I_{N}_{ᵣ}_{N}−XM=I_{N}_{ᵣ}_{N}−X(X^{H}X)⁻¹X^{H} is a projector onto the null subspace of X. Therefore, instead of obtaining a signal in a NᵣN space, we obtain its components in a NᵣN−NᵣNₜ(L+1) subspace, which represent a loss of information from the intended signal. Moreover, an estimate of h⁽ⁱ⁾ is assumed to be available in order to perform the RF cancellation stage. Therefore, a half-duplex transmission period is needed at the beginning to estimate the self-interference channel and then reduce the self-interference without affecting the intended signal when switching to full-duplex transmission. In an embodiment, while this initial period is used as a training period to estimate h⁽ⁱ⁾, two-way communications are in half-duplex fashion.

During the initial half-duplex fashion period, the transceiver receives only its own signal. The signal model in equation (6) reduces to:

y=Xh⁽ⁱ⁾+w. (9)

The estimation of the self-interference channel h⁽ⁱ⁾ is equivalent to the traditional problem of training based channel estimation. Usually, the processes to solve this problem rely on linear LS strategies. However, these methods do not exploit the particular structure of the channel. As confirmed by measurements, the self-interference channel between close-by antennas in the same transceiver, exhibits a very strong path component compared to the reflected paths, and hence the vector h⁽ⁱ⁾ contains a few dominant components. Therefore, the problem turns out to estimating a sparse channel from the observation y. Hence, mathematically, we are looking for arg minₕ∥h∥₀ such that y=Xh. This is, however, a difficult combinatorial optimization problem and may be intractable even for small size problem. Recently, it has been shown that when h is sparse enough compared to X, it is possible to replace ∥h∥₀ by ∥h∥₁ in the optimization problem and we still obtain the exact same solutions for both problems. The new problem:

$$arg {min}_{h} {‖ h ‖}_{1} such that y = Xh , \qquad ( 10 )$$

is a convex optimization problem and can be solved by linear programming. In practice, only noisy measurements are available. Therefore, the constraint y=Xh is replaced by ∥y=Xh∥₂²≦λ, for some parameter λ, to introduce the additive noise. This optimization problem is computationally tractable since it can be recast as a second-order cone programming.

The parameter λ specifies how much error we wish to allow. In the following, we propose an approach to select the regularization parameter A that is suitable for the following baseband cancellation stage. First, if we are able to obtain the exact value of h, we will have ∥y=Xh∥₂²=∥w∥₂² which can be approximated to σ²NᵣN for sufficiently large noise vector w, where σ² is the noise variance. However, the estimated value ĥ cannot exactly match the real channel h⁽ⁱ⁾. Let h^{(r)} denotes the residual channel (h^{(r)}=h⁽ⁱ⁾−ĥ⁽ⁱ⁾). In that case, we have:

y=Xĥ⁽ⁱ⁾=Xh^{(r)}+w (11)

where the term Xh^{(r)} represents the residual self-interference after the RF cancellation stage. In order to effectively estimate h^{(r)} in the following baseband cancellation stage, the power of the residual interference should be reduced to, at most, the same power of the intended signal. Therefore, using the estimated vector ĥ⁽ⁱ⁾, we want to obtain:

$$\begin{matrix}{‖ y - X {\hat{h}}^{( i )} ‖}_{2}^{2} = {‖ {Xh}^{( r )} + w ‖}_{2}^{2} \\ = ( {P}_{s} + {σ}^{2} ) {N}_{r} N ,\end{matrix} \qquad ( 12 )$$

where P_{S} is the power of the received intended signal. To that end, the regularization parameter λ is chosen high enough so that (P_{S}+σ²)NᵣN≦λ to guarantee that the residual interference is in the same order of magnitude as the intended signal. The attractive feature in compressed sensing theory is that if h⁽ⁱ⁾ is sparse, then a smaller number of measurements than the length of h⁽ⁱ⁾ is sufficient to recover h⁽ⁱ⁾. This reconstruction ability depends on some properties of the matrix X. In particular, it suffices that the matrix X satisfies the restricted isometry property (RIP) as follows. Let S denotes the number of non-zero elements in the vector h⁽ⁱ⁾. According to the definition RIP, X satisfies the RIP² (the RIP guaranties the uniqueness of the solution to the problem. In fact, for any two different S sparse vectors θ₁ and θ₂, the vector θ₁−θ₂ has at most 2S non zero elements (if the non-zero elements of θ₁ and θ₂ are not in the same positions). According to the RIP inequality, the two images of θ₁ and θ₂ are different as long as θ₁ is different from θ₂.) of order 2S with parameter δ_{S}ε[0,1], for a given integer S, if for every vector θ such that ∥θ∥₀≦2S we have:

(1−δ_{S})∥θ∥₂²≦∥Xθ∥₂²≦(1+δ_{S})∥θ∥₂². (13)

In other words, X satisfies the RIP if the singular values of all the submatrices X_{T}, formed from X by taking the columns indexed by T from X, are in └\sqrt{1−δ_{S}}, \sqrt{1+δ_{S}}┘, where T⊂{1, . . . , NₜNᵣ(L+1)} with cardinality no larger than S. It follows that, to prove the RIP for a given matrix, it suffices to bound the eigenvalues of the S×S Grammian matrix G_{T}=X_{T}^{H}X_{T} in the interval [1−δ_{S}, 1+δ_{S}], for all subsets of column indices T. According to the Ger\check{s}gorin's Disc theorem, the eigenvalues of G_{T} lie in the union of the S discs dᵢ centered at cᵢ=G_{T}(i, i) and with radius rᵢ=Σ_{j≠i, j=1}|G_{T}(i, j)|, for i=1, . . . , S. That is, for two δ_{d} and δₒ real in [0,1] and satisfying δ_{d}=δₒ=δ_{S}, if all the diagonal elements of G_{T} verify |G_{T}(i, i)−1|<δ_{d}| and all the off-diagonal elements satisfy |G_{T}(i,j)−1|<δₒ/S, then all the eigenvalues of G_{T} contained in the union of the discs dᵢ, i=1, . . . , S, are in the range [1−δ_{S}, 1+δ_{S}]. As shown in Appendix 1, it follows that the matrix X satisfies the RIP with parameter δ_{S} with probability exceeding:

$$1 - exp ( - \frac{{c}_{2} N}{{S}^{2}} ) , \qquad ( 14 )$$

where c₂ is a constant depending only on δ_{S} and specified in Appendix 1.

III. Subspace-Based Baseband Cancellation Stage

Once the two-way communications start full-duplex operation, the self-interference channel estimate obtained during the training period is used to reduce the power of the self-interference. After the RF cancellation stage, the resulting signal in baseband is given by:

$${y}_{c} ( n ) = {\sum }_{q = 1}^{{N}_{t}} {\sum }_{l = 0}^{L} {h}_{q}^{( r )} ( l ) {x}_{q} ( n - l ) + {h}_{q}^{( s )} ( l ) {s}_{q} ( n - l ) + w ( n ) , \qquad ( 15 )$$

where we use the similar vector structures as above. In the baseband cancellation stage, the task is to reduce the residual self-interference signal represented by the first term in equation (15). To that end, we need to estimate the residual self-interference channel from y_{c}(n). Since the self-signal is known, the simplest way to estimate the corresponding channel is to resort to a linear estimator. But this method will suffer from large estimation error since the intended signal appears as additive noise. Therefore, the intended signal also should be considered in the estimation process to jointly estimate the residual self-interference and the intended signal channels. In this section, we develop a subspace-based method for jointly estimating these two channels. Before presenting the channel estimator, we need to have a more tractable representation of the received signal y_{c}(n) to introduce the disclosed process. By defining:

x(n)=[x₁(n),x₂(m), . . . ,x_{N}_{ₜ}(n)]^{T},

s(n)=[s₁(n),s₂(m), . . . ,s_{N}_{ₜ}(n)]^{T},

H^{(r)}(l)=[h₁^{(r)}(l),h₂^{(r)}(l), . . . ,h_{N}_{ₜ}^{(r)}(l)],

H^{(s)}(l)=[h₁^{(s)}(l),h₂^{(s)}(l), . . . ,h_{N}_{ₜ}^{(s)}(l)], (16)

the cancelled input signal y_{c}(n) can be expressed as:

$${y}_{c} ( n ) = {\sum }_{l = 0}^{L} {H}^{( r )} ( l ) x ( n - l ) + {H}^{( s )} ( l ) s ( n - l ) + w ( n ) . \qquad ( 17 )$$

Then, we gather the two channel matrices H^{(s)}(l) and H^{(r)}(l) in one matrix H(l)=[H^{(r)}(l)H^{(s)}(l)] and define the NᵣM×2NₜN lower triangular block Toeplitz matrix:

$$H = ( \begin{matrix}H ( 0 ) & & H ( L ) & … & H ( 1 ) \\ H ( 1 ) & H ( 0 ) & & ⋱ & ⋮ \\ ⋮ & H ( 1 ) & ⋱ & & H ( l ) \\ H ( L ) & ⋮ & & ⋱ & \\ & H ( L ) & ⋱ & & H ( 0 ) \\ & & & ⋱ & ⋮ \\ & & & & H ( L )\end{matrix} ) , \qquad ( 18 )$$

where M=N+L and the transmitted data in one 2NₜN×1 vector:

x=[x^{T}(0),s^{T}(0), . . . ,x^{T}(N−1),s^{T}(N−1)]^{T}, (19)

Using these notations, the received NᵣM vector over the Nᵣ antennas is given by:

$$\begin{matrix}{y}_{c} = {[ {y}_{c}^{T} ( 0 ) , {y}_{c}^{T} ( 1 ) , … , {y}_{c}^{T} ( M - 1 ) ]}^{T} \\ = Hx + w .\end{matrix} \qquad ( 20 )$$

Note that for multi-block transmission, the vector in equation (20) is indexed according to the block number t, i.e., y_{c}(t). We omit this indexation for simplicity and we consider a given number of block to later estimate the covariance matrix of y_{c}.

We assume that the noise samples are uncorrelated, i.e., E(w(n)w*(m))=σ² if n=m and 0 if n≠m, and the noise and signal samples are also uncorrelated. It follows that, the covariance matrix R_{y}_{_{c}} of y_{c} is given by:

$$\begin{matrix}{R}_{{y}_{c}} = E ( {y}_{c} {y}_{c}^{H} ) \\ = {HR}_{x} {H}^{H} + {σ}^{2} {I}_{{N}_{r} M} ,\end{matrix} \qquad ( 21 )$$

where Rₓ is the 2NNₜ×2NNₜ covariance matrix of x.

In practice, the sample estimate, \hat{R}_{y}_{_{c}} of the covariance matrix R_{y}_{_{c}} is used in the estimation process. Considering T transmit OFDM symbols, \hat{R}_{y}_{_{c}} is obtained by a time-average:

$${\hat{R}}_{{y}_{c}} = \frac{1}{T} {\sum }_{t = 1}^{T} {y}_{c} ( t ) {y}_{c}^{H} ( t ) . \qquad ( 22 )$$

The signal subspace is the span of the columns of the matrix H and the noise subspace is the orthogonal complement to the signal subspace. By assuming independent channels between different antennas, the dimension of the signal subspace is 2NNₜ (the rank of HRₓH^{H} is 2NNₜ) and the dimension of the noise subspace is p=NᵣM−2NNₜ. To guaranty that the noise subspace is nondegenerate (p>0), the number of transmit antenna in each terminal Nₜ should be smaller than

$$⌊ \frac{{N}_{r} M}{2 N} ⌋ .$$

Therefore, the matrix R_{y}_{_{c}} has p co-orthogonal eigenvectors, denoted by vᵢ, i=1, 2, . . . , p corresponding to the smallest eigenvalue of R_{y}_{_{c}}, i.e., σ².

As the signal subspace is spanned by the 2NNₜ columns of the matrix H and by orthogonally between the signal and noise subspace, the columns of H are orthogonal to any vector in the noise subspace. Then we have:

vᵢ^{H}H=0,i=1,2, . . . ,p. (23)

From equation (23), we conclude that vᵢ spans the left null space of H. Knowing the left null space of H, it is possible to determine the space spanned by the column of H, denoted by span(H), i.e., the space containing all the linear combinations of the columns of H. Therefore, knowing the span(H) does not give the exact matrix H since there are infinitely many matrices satisfying equation (23). However, for the specific block Toeplitz matrix that we have at hand in equation (18), it can be shown that if two matrices H₁ and H₂ have the same form as in equation (18) and satisfy the conditions in equation (23), then there exists a nonsingular 2Nₜ×2Nₜ matrix C satisfying:

$${H}_{1} = {H}_{2} ( \begin{matrix}C & & & \\ & C & & \\ & & ⋱ & \\ & & & C\end{matrix} ) . \qquad ( 24 )$$

The proof of the existence of C is similar to that presented in Moulines, et al. with the additional condition of H(0) being full rank matrix. It has been proven that two Toeplitz matrices spanning the same subspace and having all zero elements above the principal diagonal are proportional with a scalar constant of proportionality. In the disclosed case, it turns out that the two matrices are related by a block diagonal matrix.

Recall that we are looking for a matrix that satisfies the set of equations in (23). Since the matrix H is entirely defined by the matrices H(0), . . . , H(L), instead of looking for the whole NᵣM×2NₜN matrix H, we can restrict the search for the Nᵣ×2Nₜ matrices H(l), l=0, . . . , L. Now considering again the set of equations in (23), each eigenvector vᵢ can be written as:

vᵢ=[vᵢ^{T}(M),vᵢ^{T}(M−1), . . . ,vᵢ^{T}(1)]^{T}, (25)

where vᵢ for m=1, M are Nᵣ×1 vectors. Then, each equation in (23) is rearranged as:

$$\begin{matrix}{\sum }_{l = 0}^{L} {v}_{i}^{H} ( n + L - l ) H ( l ) = 0 , \\ for n = L + 1 , … , M , & ( 26 a ) \\ {\sum }_{l = 0}^{L} {v}_{i}^{H} ( n + L - l ) H ( l ) + {\sum }_{l = 0}^{L} {v}_{i}^{H} ( M - l + n ) H ( l ) = 0 , \\ for n = 1 , … , L , & ( 26 b )\end{matrix}$$

or in the following matrix form:

$$\begin{matrix}{Θ}_{i} \breve{H} = 0 , i = 1 , … , p , \\ where & ( 27 ) \\ \breve{H} = {[ {H}^{T} ( 0 ) , {H}^{T} ( 1 ) , … , {H}^{T} ( L ) ]}^{T} , & ( 28 ) \\ {Θ}_{i} = \begin{matrix}( \begin{matrix}{v}_{i}^{H} ( L + 1 ) & {v}_{i}^{H} ( L ) & … & {v}_{i}^{H} ( 1 ) \\ {v}_{i}^{H} ( L + 2 ) & {v}_{i}^{H} ( L + 1 ) & … & {v}_{i}^{H} ( 2 ) \\ ⋮ & ⋮ & ⋱ & ⋮ \\ {v}_{i}^{H} ( N + L ) & {v}_{i}^{H} ( N + L - 1 ) & … & {v}_{i}^{H} ( N )\end{matrix} ) + \\ ( \begin{matrix}0 & {v}_{i}^{H} ( N + L ) & … & {v}_{i}^{H} ( N + 1 ) \\ 0 & & … & ⋮ \\ ⋮ & ⋮ & ⋱ & {v}_{i}^{H} ( N + L ) \\ 0 & 0 & … & 0\end{matrix} ) .\end{matrix} & ( 29 )\end{matrix}$$

Collecting all the θᵢ matrices in a Np×Nᵣ(L+1) matrix:

θᵢ=[θ₁^{T},θ₂^{T}, . . . ,θₚ^{T}]^{T}, (30)

we can rewrite equation (27) in a more compact form as:

θ [symbol] =0. (31)

The problem is equivalent to maximize a MUSIC-type spectrum with the spectrum function being

$${P}_{MUSIC} ( {H}^{} ) = \frac{1}{{‖ Θ {H}^{} ‖}_{F}^{2}}$$

with the additional condition of [symbol] ≠0 to avoid the all zeroes solution, where ∥.∥_{F} denotes the Frobenius norm. Therefore, the column of [symbol] can be obtained by finding a basis of the null space of θ. In practice, we perform the singular value decomposition (SVD) of θ and choose the 2Nₜ right singular vectors as the columns of [symbol] .

As discussed above, the solution is not unique. For [symbol] ₀ obtained from the SVD of θ, the intended signal channel matrix is proportional to [symbol] ₀:

[symbol]

= [symbol] ₀c, (32)

where C is a 2Nₜ×2Nₜ invertible matrix. We will next present a method to find the matrix C.

Let H₀ denote the block Toeplitz matrix in the form of equation (18) obtained from the estimated matrix [symbol] ₀. Using equation (24), the received vector in equation (20) is reformulated as:

$${y}_{c} = {H}_{0} ( \begin{matrix}C & & & \\ & C & & \\ & & ⋱ & \\ & & & C\end{matrix} ) x + w . \qquad ( 33 )$$

By multiplying the received signal by the pseudo-inverse of H₀, the modified 2NₜN×1 received signal is given by:

$${\overline{y}}_{c} = {H}_{0} ( \begin{matrix}C & & & \\ & C & & \\ & & ⋱ & \\ & & & C\end{matrix} ) x + \overline{w} . \qquad ( 34 )$$

where w̅=H₀^{#}w. By dividing the vector y̅_{c} into N vectors of size 2Nₜ×1:

y̅_{c}=[y̅_{c}^{T}(0),y̅_{c}^{T}(1), . . . ,y̅_{c}^{T}(N−1)]^{T}, (35)

we have:

$${\overline{y}}_{c} ( n ) = C ( \begin{matrix}x ( n ) \\ s ( n )\end{matrix} ) + \overline{w} ( n ) , n = 0 , … , N - 1. \qquad ( 36 )$$

From its definition, the matrix [symbol] is composed from the concatenation of two matrices, [symbol] ^{(r)} and [symbol] ^{(s)}, representing the residual self-interference channel and the intended signal channel, respectively (i.e., [symbol] =[ [symbol] ^{(r)} [symbol] ^{(s)}]). In the same way, we divide C in two 2Nₜ−Nₜ matrices C^{(r)} and C^{(s)} where the first one is associated with the residual self-interference channel and the second one is associated with the intended signal channel. Considering this division, we expand equation (34) as follows:

y̅_{c}(n)=C^{(r)}x(n)+C^{(s)}s(n)+w̅(n),n=0, . . . ,N−1. (37)

The vector y̅_{c}(n) is the sum of a deterministic term (since the self-signal matrix x(n) is known) and a stochastic term containing the intended signal received from Node 2 and the additive noise. For a large number of subcarriers, the elements of the vector s(n) approach a Gaussian distribution. Thus, we can reasonably assume that the unknown transmit symbols s(n) are Gaussian variables. Therefore, knowing the transmit vector x(n) and conditioned on the matrix C^{(s)}, y̅_{c}(n) is a Gaussian vector with mean C^{(r)}x(n) and covariance matrix P=C(s)R_{S}C^{(s)H}+σ²( [symbol] ₀^{H} [symbol] ₀)⁻¹. Adopting the Gaussian hypothesis, the log-likelihood function is given by:

$$L ( {C}^{( r )} , {S}^{( s )} ) = - N log ( det ( P ) ) - {\sum }_{n = 0}^{N - 1} {( {\overline{y}}_{c} ( n ) - {C}^{( r )} x ( n ) )}^{H} {P}^{- 1} ( {\overline{y}}_{c} ( n ) - {C}^{( r )} x ( n ) ) . \qquad ( 38 )$$

The Maximum-Likelihood (ML) estimates of C^{(r)} and C^{(s)} maximize the function (.,.) given in equation (38). The direct maximization of the cost function L(.,.) requires a 4Nₜ²-dimensional grid search, which is intractable in practice. To overcome this complexity, we look to a closed-form expression of the solution. Noting that L(.,.) is a separable function of the matrices to estimate, we first minimize the cost function with respect to one matrix. The obtained minimum is a function of the other matrix. Then we introduce this minimum back in the expression of the cost function which becomes a single variable function. Minimizing this new function yields the global maximum of the original log-likelihood function. We first maximize the log-likelihood function in equation (38) with respect to P. The solution of this optimization problem is:

$${P}_{ML} = \frac{1}{N} {\sum }_{n = 0}^{N - 1} ( {\overline{y}}_{c} ( n ) - {C}^{( r )} x ( n ) ) {( {\overline{y}}_{c} ( n ) - {C}^{( r )} x ( n ) )}^{H} \qquad ( 39 )$$

Substituting P by P_{ML} into the log-likelihood function in equation (38), we obtain the so-called compressed likelihood function, that depends only on the unknown matrix C^{(r)}:

$$L ( {C}^{( r )} ) = - log ( det ( {\sum }_{n = 0}^{N - 1} ( {\overline{y}}_{c} ( n ) - {C}^{( r )} x ( n ) ) {( {\overline{y}}_{c} ( n ) - {C}^{( r )} - x ( n ) )}^{H} ) ) - Ntrace ( {I}_{2 {N}_{t}} ) . \qquad ( 40 )$$

The ML estimate of C^{(r)} is given by:

$${C}_{ML}^{( r )} = arg {min}_{{C}^{( r )}} det ( {\sum }_{n = 0}^{N - 1} ( {\overline{y}}_{c} ( n ) - {C}^{( r )} x ( n ) ) {( {\overline{y}}_{c} ( n ) - {C}^{( r )} x ( n ) )}^{H} ) . \qquad ( 41 )$$

At this point, we need to introduce some definitions. Let \tilde{C}^{(r)} denotes the 2Nₜ²×1 vector obtained by stacking all the columns of C^{(r)T} on top of each other (i.e., \tilde{C}^{(r)}=vec(C^{(r)T})) and \tilde{x}(n) be the 2Nₜ×2Nₜ² matrix given by:

\tilde{x}(n)=diag(x^{T}(n), . . . ,x^{T}(n)). (42)

Using these notations, the minimization problem in equation (41) is alternatively expressed as:

$${\tilde{C}}_{ML}^{( r )} = arg {min}_{{\tilde{C}}^{( r )}} det ( {\sum }_{n = 0}^{N - 1} ( {\overline{y}}_{c} ( n ) - \tilde{x} ( n ) {\tilde{C}}^{( r )} ) {( {\overline{y}}_{c} ( n ) - \tilde{x} ( n ) {\tilde{C}}^{( r )} )}^{H} ) . \qquad ( 43 )$$

This modified problem allows us to obtain the following simple least square (LS) solution:

$${\tilde{C}}_{LS}^{( r )} = {( {\sum }_{n = 0}^{N - 1} {\tilde{x}}^{H} ( n ) \tilde{x} ( n ) )}^{- 1} {\sum }_{n = 0}^{N - 1} {\tilde{x}}^{H} ( n ) {\overline{y}}_{c} ( n ) . \qquad ( 44 )$$

Since we are interested in the ML estimate, we define Σ_{ML} as the difference between the ML and LS estimates:

ξ_{ML}=\tilde{C}_{ML}^{(r)}−\tilde{C}_{LS}^{(r)}, (45)

and let ξ=\tilde{C}^{(r)}−\tilde{C}_{Ls}^{(r)} denote the difference between the ML solution and a given value of \tilde{C}^{(r)}. We also consider the following two notations:

$$d ( n ) = {\overline{y}}_{c} ( n ) - \tilde{x} ( n ) {\tilde{C}}_{LS}^{( r )} , \\ {\hat{R}}_{d} = \frac{1}{N} {\sum }_{n = 0}^{N - 1} d ( n ) {d}^{H} ( n ) . \qquad ( 46 )$$

As shown in Appendix 2, the optimization problem at hand is equivalent to:

$${ξ}_{ML} = arg {min}_{ξ} {\sum }_{n = 0}^{N - 1} {ξ}^{H} {\tilde{x}}^{H} ( n ) {\hat{R}}_{d}^{- 1} \tilde{x} ( n ) ξ - {d}^{H} ( n ) {\hat{R}}_{d}^{- 1} \tilde{x} ( n ) ξ - ξ {x}^{H} ( n ) {\hat{R}}_{d}^{- 1} d ( n ) . \qquad ( 47 )$$

Its solution is easily obtained by nulling the derivative with respect to f:

$${ξ}_{ML} = {( {\sum }_{n = 0}^{N - 1} {\tilde{x}}^{H} ( n ) {\hat{R}}_{d}^{- 1} \tilde{x} ( n ) )}^{- 1} {\sum }_{n = 0}^{N - 1} {\tilde{x}}^{H} ( n ) {\hat{R}}_{d}^{- 1} d ( n ) . \qquad ( 48 )$$

Rearranging the expression in equation (48) using the notations given above, the ML estimate of \tilde{C}^{(r)} is given by:

$${\tilde{C}}_{ML}^{( r )} = {( {\sum }_{n = 0}^{N - 1} {\tilde{x}}^{H} ( n ) {\hat{R}}_{d}^{- 1} \tilde{x} ( n ) )}^{- 1} {\sum }_{n = 0}^{N - 1} {\tilde{x}}^{H} ( n ) {\hat{R}}_{d}^{- 1} {\overline{y}}_{c} ( n ) , \qquad ( 49 )$$

Note that the difference between the ML and LS estimates comes from the term \hat{R}_{d}⁻¹ in equation (49).

For completeness, we present a method to find the ambiguity matrix of the intended signal channel C^{(s)}. It can be obtained from the Eigen-decomposition of the matrix P_{ML} obtained in equation (39) as follows:

C_{ML}^{(s)}=U_{P}D_{P}Φ, (50)

where D_{P} is a diagonal matrix containing the Nₜ most significant eigenvalues of the matrix P_{ML} and the columns of U_{P} are the corresponding 2Nₜ×1 eigenvectors. The matrix Φ is a diagonal phase matrix which can be easily found using a small number of training symbols.

### APPENDIX 1

Following the discussion in Section II, it is desirable to establish bounds on |G_{T}(i, i)−1| and Σ_{j=1,j≠i}^{S}|G_{T}(i,j)|, for all subsets T. In the following proof, the elements of X are Gaussian random variables with mean 0 and variance 1=N. The matrix X also verifies the RIP when its elements have arbitrary variance σₓ² by multiplying each term in the inequality in equation (13) by N/σₓ². Moreover, we suppose a real matrix X. Using Lemma 5 in Haupt, et al., each diagonal element of G_{T}(i, j)=Σₙ₌₁^{N}|xₚ_{ᵢ}(n)|²:

$$Pr ( \vert {G}_{T} ( i , i ) \vert \geq {δ}_{d} ) \geq 2 exp ( - \frac{N {δ}_{d}}{16} ) . \qquad ( 52 )$$

Each column of X contains the N transmitted samples from one of the Nₜ transmitted streams. Therefore, there are exactly Nₜ different values for G_{T}(i, i). By the union bound, we have for every subset T and for all i=1, . . . , S:

$$Pr ( {⋃}_{T} {{⋃}_{i = 1}}^{S} \vert {G}_{T} ( i , i ) \vert \geq {δ}_{d} ) \leq 2 {N}_{t} exp ( - \frac{N {δ}_{d}}{16} ) . \qquad ( 53 )$$

For a given subset T, any off-diagonal element G (i, j) is the inner product between the mᵢ and mⱼ columns of X. For convenience, we write mᵢ as mᵢ=nᵢ+pᵢNᵣ+dᵢNᵣNₜ with nᵢε[1, Nᵣ], pᵢε[0, Nₜ−1] and dᵢε[0, L]. Depending on mᵢ and mⱼ, we distinguish the following different cases:
1) If nᵢ≠nⱼ, then G_{T}(i, i)=0.
2) If nᵢ=nⱼ and dᵢ=dⱼ then G_{T}(i,j) is the sum of N terms
G_{T}(i,j)=Σₙ₌₁^{N}xₚ_{ᵢ}₊₁(n)xₚ_{ⱼ}₊₁(n).
The entries of the previous summation are independent. Therefore, applying Lemma 4 in Haupt, et al., we obtain the following bound:

$$Pr ( \vert {G}_{T} ( i , j ) \vert \geq {δ}_{S} / S ) \leq 2 exp ( - \frac{{δ}_{0}^{2} N}{4 {S}^{2} ( 1 + \frac{{δ}_{0}}{2 S} )} ) . \qquad ( 54 )$$

The total number of unique elements having this form is

$$\frac{{N}_{t}^{2} - {N}_{t}}{2} .$$

3) If nᵢ=nⱼ, dᵢ≠dⱼ, and pᵢ≠pⱼ, then G_{T}(i,j)=Σₙ₌₁^{N-|d}^{ᵢ}^{-d}^{ⱼ}^{|}Xₚ_{ᵢ}₊₁(n)xₚ_{ⱼ}₊₁(n+|dᵢ−dⱼ|) is the sum of N−|dᵢ−dⱼ| independent terms. Using the same formula as in case 2 gives:

$$Pr ( \vert {G}_{T} ( i , j ) \vert \geq \frac{{δ}_{S}}{S} ) \leq 2 exp ( - \frac{{δ}_{0}^{2} N}{4 {S}^{2} ( \frac{N - \vert {d}_{i} - {d}_{j} \vert}{N} ) + \frac{{δ}_{0}}{2 S}} ) . \qquad ( 55 )$$

There are L(Nₜ²−Nₜ)/2 different terms having this form.
4) If nᵢ=nⱼ, dᵢ≠dⱼ, and pᵢ=pⱼ, then G_{T}(i,j) is given by:

$${G}_{T} ( i , j ) = {\sum }_{n = 1}^{N - \vert {d}_{i} - {d}_{j} \vert} {x}_{{p}_{i} + 1} ( n ) {x}_{{p}_{j} + 1} ( n + \vert {d}_{i} - {d}_{j } \vert ) . \qquad ( 56 )$$

Unlike the other cases, the entries of the summation are no longer independent since each element xₚ_{ᵢ}₊₁(n) appears in two entries. For example, consider that |dᵢ−dⱼ|=1, then we have:

G_{T}(i,j)=xₚ_{ᵢ}₊₁(2)xₚ_{ᵢ}₊₁(1)+xₚ_{ᵢ}₊₁(3)xₚ_{ᵢ}₊₁(2)+xₚ_{ᵢ}₊₁(4)xₚ_{ᵢ}₊₁(3)+ . . . +xₚ_{ᵢ}₊₁(N)xₚ_{ᵢ}₊ᵢ(N−1) (57)
Since the odd-order terms are mutually independent, and the even-order terms are also mutually independent, the summation in equation (57) can be split into two sums, each for the mutually independent variables. Therefore:

$$Pr ( \vert {G}_{T} ( i , j ) \vert \geq \frac{{δ}_{0}}{S} ) \leq Pr ( \vert {G}_{T}^{1} ( i , j ) \vert \geq \frac{{δ}_{0}}{2 S} or \vert {G}_{T}^{2} ( i , j ) \vert \geq \frac{{δ}_{0}}{2 S} ) \leq 2 max ( Pr ( \vert {G}_{T}^{1} ( i , j ) \vert \geq \frac{{δ}_{0}}{2 S} ) , \vert {G}_{t}^{2} ( i , j ) \vert \geq \frac{{δ}_{0}}{2 S} ) \leq 4 exp ( - \frac{{δ}_{0}^{2} N}{6 {S}^{2 }} ) , \qquad ( 58 )$$

where the last equality follows from the upper bound used in equation (55).

We gather the previous results along with the union bound to establish an upper bound on the probability that all the elements G_{T}(i,j), for any subset T and i≠j, satisfy

$$\vert {G}_{T} ( i , j ) \vert \geq \frac{{δ}_{0}}{S}$$

$$Pr ( {⋃}_{T} {{⋃}^{S}}_{j = 1} \vert {G}_{T} ( i , j ) \vert \geq \frac{{δ}_{0}}{S} ) \leq 2 ( L + 1 ) {N}_{t}^{2} exp ( - \frac{{δ}_{0}^{2} N}{6 {S}^{2 }} ) . \qquad ( 59 )$$

To obtain the result claimed in Section II, let δ_{d}=2δ_{S}/3, δ₀=δ_{S}/3 and use equations (53) and (59) to obtain:

$$Pr ( X not satisfying RIP ) \leq 2 ( L + 1 ) {N}_{t}^{2} exp ( - \frac{{δ}_{S}^{2} N}{54 {S}^{2}} ) + 2 {N}_{t} exp ( - \frac{N {δ}_{S}}{36} ) \leq ( 2 ( L + 1 ) {N}_{t}^{2} + 2 {N}_{t} ) exp ( - \frac{{δ}_{S}^{2} N}{54 {S}^{2}} ) . \qquad ( 60 )$$

Define c₁=2(L+1)Nₜ²+2Nₜ and for c₂<δ_{S}²/54, we obtain:

$$Pr ( X not satisfying RIP ) \leq exp ( - \frac{{c}_{2} N}{{S}^{2}} ) , \qquad ( 61 )$$

for any

$$N \geq \frac{54 {S}^{2} log ( {c}_{1} )}{- 54 {c}_{2} + {δ}_{S }^{2}} N \geq 54 S 2 log ( c 1 ) - 54 c 2 + \_ 2 S .$$

### APPENDIX 2

Using the notations introduced in equations (45) and (46), we can write:

$$( {\overline{y}}_{c} ( n ) - {\tilde{C}}^{( r )} \tilde{x} ( n ) ) {( {\overline{y}}_{c} ( n ) - {\tilde{C}}^{( r )} \tilde{x} ( n ) )}^{H} = ( {\overline{y}}_{c} ( n ) - ( {\tilde{C}}_{LS}^{( r )} + ξ ) \tilde{x} ( n ) ) {( {\overline{y}}_{c} ( n ) - ( {\tilde{C}}^{( r )} + ξ ) \tilde{x} ( n ) )}^{H} , \qquad ( 62 )$$

and further develop to obtain:

d(n)d^{H}(n)−d(n)(\tilde{x}(n)ξ)^{H}−\tilde{x}(n)ξd^{H}(n)+\tilde{x}(n)ξξ^{H}\tilde{x}^{H}(n). (63)

Injecting equation (63) into the cost function in equation (43), we obtain the following expression:

$$det ( {R}_{d} + 1 / N {\sum }_{n = 0}^{N - 1} d ( n ) {( \tilde{x} ( n ) ξ )}^{H} - \tilde{x} ( n ) ξ {d}^{H} ( n ) + \tilde{x} ( n ) ξ {ξ}^{H} {\tilde{x}}^{H} ( n ) ) , \qquad ( 64 )$$

or the following equivalent cost function:

$$det ( I + 1 / {NR}_{d}^{- 1} {\sum }_{n = 0}^{N - 1} d ( n ) {( \tilde{x} ( n ) ξ )}^{H} - \tilde{x} ( n ) ξ {d}^{H} ( n ) + \tilde{x} ( n ) ξ {ξ}^{H} {\tilde{x}}^{H} ( n ) ) , \qquad ( 65 )$$

Noting that, when N is large, the LS and ML estimates are close to the true value. Therefore, the vector ξ can be assumed to be small. And, using the fact that, for ∥M∥<<1,det(I+M)≈1+trace(M) and the property that the trace is invariant under permutations, the minimization problem can be reduced to the one given in equation (47).

FIG. 6 is a block diagram of a processing system 600 that may be used for implementing the devices and methods disclosed herein. Specific devices may utilize all of the components shown, or only a subset of the components and levels of integration may vary from device to device. Furthermore, a device may contain multiple instances of a component, such as multiple processing units, processors, memories, transmitters, receivers, etc. The processing system 600 may comprise a processing unit 601 equipped with one or more input/output devices, such as a speaker, microphone, mouse, touchscreen, keypad, keyboard, printer, display, and the like. The processing unit 601 may include a central processing unit (CPU) 610, memory 620, a mass storage device 630, a network interface 650, an I/O interface 660, and an antenna circuit 670 connected to a bus 640. The processing unit 601 also includes an antenna element 675 connected to the antenna circuit.

The bus 640 may be one or more of any type of several bus architectures including a memory bus or memory controller, a peripheral bus, video bus, or the like. The CPU 610 may comprise any type of electronic data processor. The memory 620 may comprise any type of system memory such as static random access memory (SRAM), dynamic random access memory (DRAM), synchronous DRAM (SDRAM), read-only memory (ROM), a combination thereof, or the like. In an embodiment, the memory 620 may include ROM for use at boot-up, and DRAM for program and data storage for use while executing programs.

The mass storage device 630 may comprise any type of storage device configured to store data, programs, and other information and to make the data, programs, and other information accessible via the bus 640. The mass storage device 630 may comprise, for example, one or more of a solid state drive, hard disk drive, a magnetic disk drive, an optical disk drive, or the like.

The I/O interface 660 may provide interfaces to couple external input and output devices to the processing unit 601. The I/O interface 660 may include a video adapter. Examples of input and output devices may include a display coupled to the video adapter and a mouse/keyboard/printer coupled to the I/O interface. Other devices may be coupled to the processing unit 601 and additional or fewer interface cards may be utilized. For example, a serial interface such as Universal Serial Bus (USB) (not shown) may be used to provide an interface for a printer.

The antenna circuit 670 and antenna element 675 may allow the processing unit 601 to communicate with remote units via a network. In an embodiment, the antenna circuit 670 and antenna element 675 provide access to a wireless wide area network (WAN) and/or to a cellular network, such as Long Term Evolution (LTE), Code Division Multiple Access (CDMA), Wideband CDMA (WCDMA), and Global System for Mobile Communications (GSM) networks. Additional, in some embodiments, the antenna circuit 670 operates in Full Duplex (FD) mode. In some embodiments, the antenna circuit 670 and antenna element 675 may also provide Bluetooth and/or WiFi connection to other devices. In an embodiment, the antenna circuit 670 includes a transmitted signal cancellation system.

The processing unit 601 may also include one or more network interfaces 650, which may comprise wired links, such as an Ethernet cable or the like, and/or wireless links to access nodes or different networks. The network interface 601 allows the processing unit 601 to communicate with remote units via the networks 680. For example, the network interface 650 may provide wireless communication via one or more transmitters/transmit antennas and one or more receivers/receive antennas. In an embodiment, the processing unit 601 is coupled to a local-area network or a wide-area network for data processing and communications with remote devices, such as other processing units, the Internet, remote storage facilities, or the like.

The following references are incorporated herein by reference:
[1] J. I. Choi, M. Jain, K. Srinivasan, P. Levis, and S. Katti, “Achieving single channel, full duplex wireless communication,” in Proc. ACM MobiCom, New York, N.Y., USA, 2010, pp. 1-12.
[2] M. Duarte and A. Sabharwal, “Full-duplex wireless communications using off-the-shelf radios: Feasibility and first results,” in Proc. ASILOMAR Signals, Syst., Comput., 2010, pp. 1558-1562.
[3] M. Duarte, C. Dick, and A. Sabharwal, “Experiment-driven characterization of full-duplex wireless systems,” IEEE Trans. Wireless Comm., vol. 11, no. 12, pp. 4296-4307, 2012.
[4] D. Kim, H. Ju, S. Park, and D. Hong, “Effects of channel estimation error on full-duplex two-way networks,” IEEE Trans. Vehicular Technology, vol. 62, no. 9, p. 4667, 2013.
[5] S. Li and R. D. Murch, “Full-duplex wireless communication using transmitter output based echo cancellation,” in Proc. IEEE Global Telecommun. Conf. IEEE, 2011, pp. 1-5.
[6] E. Candes and T. Tao, “Decoding by linear programming,” IEEE Trans. Inf. Theory, vol. 51, no. 12, pp. 4203-4215, 2005.
[7] E. Candes, J. Romberg, and T. Tao, “Stable signal recovery from incomplete and inaccurate measurements,” Comm. Pure appl. math., vol. 59, no. 8, pp. 1207-1223, 2006.
[8] W. U. Bajwa, J. Haupt, A. M. Sayeed, and R. Nowak, “Compressed channel sensing: A new approach to estimating sparse multipath channels,” Proceedings of the IEEE, vol. 98, no. 6, pp. 1058-1076, 2010.
[9] G. Taubock and F. Hlawatsch, “Compressed sensing based estimation of doubly selective channels using a sparsity-optimized basis expansion,” in Proc. European Signal Processing Conf.(EUSIPCO'08), 2008.
[10] R. Schmidt, “Multiple emitter location and signal parameter estimation,” IEEE Trans. Antennas and Propagation, vol. 34, no. 3, pp. 276-280, 1986.
[11] S. M. Kay, Fundamentals of statistical signal processing, Volume 1: Estimation theory. Prentice Hall, 1993.
[12] M.-A. Baissas and A. M. Sayeed, “Pilot-based estimation of time-varying multipath channels for coherent CDMA receivers,” IEEE Trans. Signal Process., vol. 50, no. 8, pp. 2037-2049, 2002.
[13] X. Ma, G. B. Giannakis, and S. Ohno, “Optimal training for block transmissions over doubly selective wireless fading channels,” IEEE Trans. Signal Process., vol. 51, no. 5, pp. 1351-1366, 2003.
[14] H. Minn and N. Al-Dhahir, “Optimal training signals for MIMO OFDM channel estimation,” IEEE Trans. Wireless Comm., vol. 5, no. 5, pp. 1158-1168, 2006.
[15] S. S. Chen, D. L. Donoho, and M. A. Saunders, “Atomic decomposition by basis pursuit,” SIAM journal on scientific computing, vol. 20, no. 1, pp. 33-61, 1998.
[16] J. Haupt, W. U. Bajwa, G. Raz, and R. Nowak, “Toeplitz compressed sensing matrices with applications to sparse channel estimation,” IEEE Trans. Inf. Theory, vol. 56, no. 11, pp. 5862-5875, 2010.
[17] E. Moulines, P. Duhamel, J.-F. Cardoso, and S. Mayrargue, “Subspace methods for the blind identification of multichannel FIR filters,” IEEE Trans. Signal Process., vol. 43, no. 2, pp. 516-525, 1995.
[18] H. Ochiai and H. Imai, “Performance analysis of deliberately clipped OFDM signals,” IEEE Trans. Comm., vol. 50, no. 1, pp. 89-101, 2002.
[19] S. Talwar, M. Viberg, and A. Paulraj, “Blind separation of synchronous co-channel digital signals using an antenna array. I. algorithms,” IEEE Trans. Signal Process., vol. 44, no. 5, pp. 1184-1197, 1996.
[20] L. L. Scharf, Statistical signal processing. Addison-Wesley Reading, 1991, vol. 98.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A method for reducing self-interference (SI) in a full-duplex capable transceiver, the method comprising:
obtaining an adjusted signal, wherein the adjusted signal is a difference signal between a received signal in an analog domain and an estimated SI, wherein the estimated SI is estimated according to an SI received at a receiver during a half-duplex operation; and
obtaining an intended signal, wherein the intended signal is a difference signal between the adjusted signal in a digital domain and an estimated residual SI, and wherein the estimated residual SI is an amount of SI remaining in the adjusted signal after removal of the estimated SI from the received signal.

2. The method of claim 1, wherein determining the difference signal is performed before the adjusted signal arrives at a low noise amplifier.

3. The method of claim 1, wherein determining the difference signal is performed before the adjusted signal arrives at an analog-to-digital converter.

4. The method of claim 1, further comprising improving an accuracy of SI channel estimation by adjusting a transmit power according to a transmitted signal received at the transceiver during the half-duplex operation.

5. The method of claim 1, wherein the estimated SI is determined according to any one of the following: a compressed-sensing-based procedure; a mixed-norm optimization criteria that returns non-zero coefficients for a compressed-sensing based self-interference channel estimate; and a subspace-based estimator.

6. The method of claim 1, wherein the estimated residual SI is obtained according to determining a covariance matrix of an input signal.

7. The method of claim 1, wherein the estimated residual SI is obtained according to solving an ambiguity matrix for a residual SI channel using a transmit SI signal according to a maximum likelihood function.

8. A method for reducing self-interference (SI) in a full-duplex capable transceiver, the method comprising:
obtaining, by the transceiver, an adjusted signal, wherein the adjusted signal is a difference signal between a received signal in an analog domain and an estimated SI signal, wherein the estimated SI signal is estimated according to an SI signal received at a receiver during a training period during a half-duplex operation; and
obtaining, by the transceiver, an intended signal according to an estimated residual SI signal and the adjusted signal.

9. The method of claim 8, wherein the adjusted signal is determined in a radio-frequency (RF) domain before the received signal is amplified and converted into a digital signal.

10. The method of claim 8, wherein the intended signal is obtained by subtracting the residual SI from the adjusted signal in a baseband.

11. The method of claim 8, further comprising reducing a power of the SI according to the estimated SI obtained in the training period.

12. The method of claim 8, wherein the estimated SI signal is determined during the training period according to a compressed-sensing-based procedure.

13. The method of claim 8, wherein the estimated SI signal is determined during the training period according to a mixed-norm optimization criteria that returns non-zero coefficients for a compressed-sensing based self-interference channel estimate.

14. A full-duplex capable wireless network component, comprising:
an antenna sub-system configured for full-duplex operation;
a self-interference (SI) channel estimation component configured to estimate an SI signal during a training phase mode;
an radio-frequency (RF) self-interference cancellation stage component configured to obtain an adjusted RF signal according to a difference signal between a received RF signal and the estimated SI signal in a RF domain during a full-duplex operation mode;
an analog-to-digital converter (ADC) configured to convert the adjusted RF signal to a digital adjusted signal; and
a baseband SI cancellation stage configured to obtain the digital intended signal in a digital domain according to a difference signal between the digital adjusted signal and a residual SI signal.

15. The full-duplex capable wireless network component of claim 14, wherein the SI channel estimation component is configured to determine the estimated SI according to a compressed-sensing-based procedure.

16. The full-duplex capable wireless network component of claim 14, wherein the SI channel estimation component is configured to determine the estimated SI signal according to a mixed-norm optimization criteria that returns non-zero coefficients for a compressed-sensing based self-interference channel estimate.

17. The full-duplex capable wireless network component of claim 14, wherein the baseband SI cancellation stage is configured to determine the residual SI signal according to a subspace procedure.

18. The full-duplex capable wireless network component of claim 14, wherein the training phase mode comprises a half-duplex mode.

19. The full-duplex capable wireless network component of claim 14, wherein the baseband SI cancellation stage component is further configured to determine a covariance matrix of an input signal.

20. The full-duplex capable wireless network component of claim 14, wherein the baseband SI cancellation stage component is further configured to solve an ambiguity matrix for the residual SI channel using a transmit SI signal according to a maximum likelihood function.
